(19) United States
(12) Patent Application Publication
(10) Pub. No.: US 2024/0403387 A1
(43) Pub. Date: Dec. 5, 2024

(54) LOG NORMALIZATION SYSTEM AND LOG NORMALIZATION METHOD

(71) Applicant: Hitachi, Ltd., Tokyo (JP)

(72) Inventor: Takaya IDE, Tokyo (JP)

(21) Appl. No.: 18/582,033

(22) Filed: Feb. 20, 2024

(30) Foreign Application Priority Data
May 29, 2023 (JP) 2023-087720

(51) Int. Cl. G06F 18/22; G06F 16/33

(52) U.S. Cl. CPC G06F 18/22; G06F 16/334

(57) ABSTRACT

Accuracy and processing speed for searching in searching for a pattern that matches a log is achieved with a log normalization apparatus for normalizing a log output from an information processing system into a structured log. The apparatus has a log input unit that receives a log output from an information processing system; a storage unit that stores pattern information, which are patterns of logs, and a first priority information indicating a first priority for pattern matching corresponding to a log transmission source. A pattern matching unit is configured to, when the log received is a log transmission source corresponding to the first priority information, perform pattern matching between the log and the patterns in the pattern information using a pattern corresponding to the first priority and convert the log into a normalized log using the pattern matched, and the normalized log converted by the pattern matching unit is output.

### CROSS-REFERENCE TO RELATED APPLICATION

The present application claims priority from Japanese application JP2023-087720, filed on May 29, 2023, the content of which is hereby incorporated by reference into this application.

### BACKGROUND OF THE INVENTION

### 1. Field of the Invention

The present invention relates to a technique for processing a log output from an information processing system.

### 2. Description of Related Art

A log output from a system is used to monitor and debug the system. For example, D. Schipper, M. Aniche and A. van Deursen, “Tracing Back Log Data to its Log Statement: From Research to Practice,” 2019 IEEE/ACM 16th International Conference on Mining Software Repositories, 2019, pp. 545-549 discloses a method of searching for a template matching an input log using Term Frequency-Inverse Document Frequency (TF-IDF), analyzing the log, and converting the log into a structured log. US20190163678A1 (Generating structured metrics from log data) discloses a method including: ingesting data including logs obtained from a plurality of systems via a network by a data intake and query system; receiving user input indicating a scope for retrieving data and a criterion expressed in a structured language by the data intake and query system; retrieving data based on the scope indicated by the user input; extracting a first field value and a second field value from the retrieved data based on the criterion and the scope indicated by the user input by the data intake and query system, the first field value including a first numerical value indicating a measured characteristic of a computing device, the second field value including a first dimension; and storing a first structured metric and the first dimension in a time-series metrics store by the data intake and query system, wherein the first structured metric includes the first numerical value, and the first dimension is associated with the first numerical value.

### SUMMARY OF THE INVENTION

In monitoring an information processing system using many types of software or in monitoring a large number of information processing systems, various types of logs are output, and many types of patterns (templates) are required to normalize (structure) the output logs. In this aspect, D. Schipper, M. Aniche and A. van Deursen, “Tracing Back Log Data to its Log Statement: From Research to Practice,” discloses a technique of searching for a template matching an input log using TF-IDF, analyzing the log, and converting the log into a structured log. Similarly, US20190163678A1 discloses a technique of searching for a Source Type matching an input log in an undisclosed method and generating metadata equivalent to a structured log.

However, in both D. Schipper, M. Aniche and A. van Deursen, “Tracing Back Log Data to its Log Statement: From Research to Practice,” and US20190163678A1, a time required to search for a pattern that matches an input log increases in proportion to the number of patterns (templates, Source Types), and possibility of searching for a wrong pattern increases. For this reason, for example, when a log is normalized using data in which a huge number of patterns including all patterns of logs that can be output by famous tools, middleware, and libraries are preset, there may be a problem in processing speed and accuracy for searching.

An object of the present invention is to improve an accuracy and a processing speed for searching in searching for a pattern that matches an input log from among a huge number of patterns.

A log normalization system according to the invention is configured to be a log normalization apparatus for normalizing a log output from an information processing system into a structured log, the log normalization apparatus including: a log input unit configured to receive a log output from the information processing system; a storage unit configured to store pattern information, which is patterns of a plurality of logs, and a first priority information indicating a first priority for pattern matching corresponding to a log transmission source; a pattern matching unit configured to, when the log received is the log transmission source corresponding to the first priority information, perform pattern matching between the log and the patterns in the pattern information using a pattern corresponding to the first priority and convert the log into a normalized log using the pattern matched; and a log output unit configured to output the normalized log converted by the pattern matching unit.

According to the invention, it is possible to improve an accuracy and a processing speed for searching in searching for a pattern that matches a log.

### BRIEF DESCRIPTION OF THE DRAWINGS

FIG. 1 is a diagram illustrating an example of a system configuration according to an embodiment of the invention;

FIG. 2 is a diagram illustrating an example of a hardware configuration according to the embodiment of the invention;

FIG. 3 is a diagram illustrating an example of an operation screen according to the embodiment of the invention;

FIG. 4A is a diagram illustrating an example of a configuration of configuration information according to the embodiment of the invention;

FIG. 4B is a diagram illustrating an example of a configuration of configuration information according to the embodiment of the invention;

FIG. 5 is a diagram illustrating an example of pattern information according to the embodiment of the invention;

FIG. 6 is a diagram illustrating an example of software information according to the embodiment of the invention;

FIG. 7 is a diagram illustrating an example of history information according to the embodiment of the invention;

FIG. 8 is a flowchart illustrating an example of processing in a software identification unit according to the embodiment of the invention;

FIG. 9 is a flowchart illustrating an example of pattern matching processing in a pattern matching unit according to the embodiment of the invention;

FIG. 10 is a flowchart illustrating an example of pattern matching processing according to the embodiment of the invention; and

FIG. 11 is a flowchart illustrating an example of processing in a pattern generation unit according to the embodiment of the invention.

### DESCRIPTION OF EMBODIMENTS

Embodiments of the invention will be described in detailed below in accordance with the accompanying drawings.

However, the invention is not limited to the embodiments described below, and includes various modifications and equivalent configurations within the scope of the appended claims. For example, the above-described embodiments are described in detail so as to explain the invention in an easy-to-understand manner, and the invention is not necessarily limited to a configuration including all components described.

In the embodiments, each piece of information is described in the form of “table” or “text data in JSON format”, but the information is not necessarily required to be expressed in a data structure by table, and may be expressed in a data structure such as a list, a database (DB), or a queue, or in text data in a format such as Yaml or XML, or in other formats. Thus, “table”, “list”, “DB”, “queue”, and the like may be simply called “information” so as to indicate that there is no dependence on data structures. In addition, expressions such as “identification information”, “identifier” and “identification (ID)” can be used to describe the contents of each piece of information, and they can be replaced with each other.

In the embodiments, processing that is started to be executed when a button on a Graphical User Interface (GUI) is pressed may be started to be executed when a corresponding Application Programming Interface (API) is called.

Information such as programs, tables, and files that enable respective functions can be stored in a storage device such as a memory, a hard disk, or a Solid State Drive (SSD), or in a recording medium such as an IC card, an SD card, or a DVD.

The above-described configurations, functions, processing units, and the like may be implemented by hardware, for example, by designing a part or all thereof as an integrated circuit, or may be implemented by software by a processor interpreting and executing a program for implementing each function.

In the following description, a program such as “XX function” may be described as a subject. However, since the program performs predetermined processing using a main storage device 204 and a communication control device 202 by being executed by a processor 201, the processor 201 may be described as a subject. In addition, processing that is disclosed with a program as a subject may be processing performed by a programming apparatus.

When data acquisition or calling of a program function is performed between different electronic computers, a remote procedure call using a communication protocol such as a Web API may be actually performed.

### First Embodiment

A log (message) output from an information processing system is used to monitor and debug the information processing system. Log formats include an unstructured log which is output as a text, and a structured log structured by JavaScript (registered trademark) Object Notation (JSON). They are shown below as example 1 and example 2, respectively.

### (Example 1) Unstructured Log

[2022-12-01T10:51:17.33] ERROR: table sample does not exist

### (Example 2) Structured Log

{
“timestamp”: 1669891877330,
“log_level”: “error”,
“table”: “sample”,
“message”: “ERROR: table sample does not exist”
}

A structured log is more suitable for monitoring and analysis using machine processing such as tabulation than an unstructured log. For this reason, conversion (normalization) of an unstructured log into a structured log is performed as preprocessing for analysis. For this log normalization, for example, the techniques described in D. Schipper, M. Aniche and A. van Deursen, “Tracing Back Log Data to its Log Statement: From Research to Practice,” and US20190163678A1 described above can be used. An information processing system includes various systems and apparatuses that output such logs.

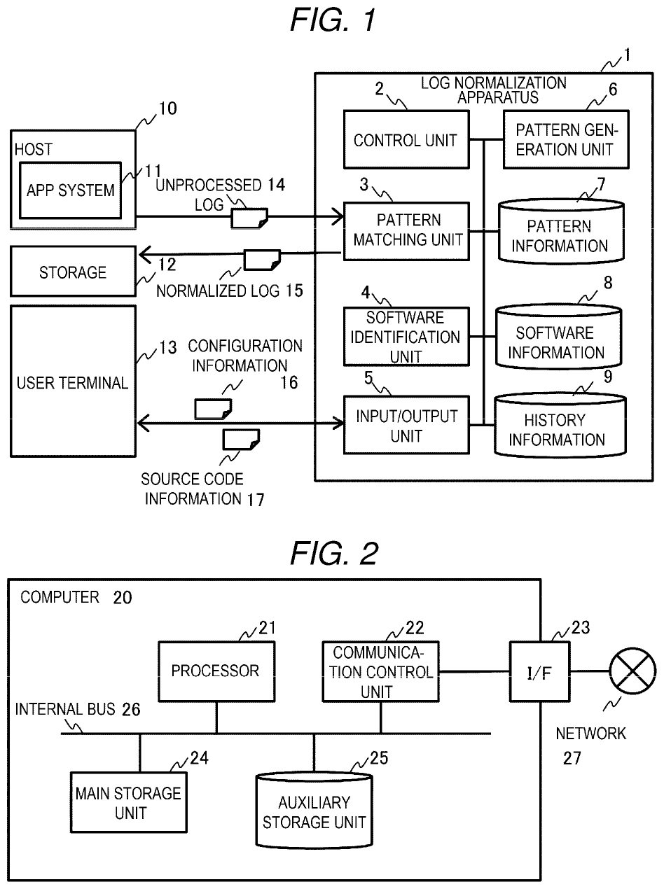

FIG. 1 is an example of a system configuration according to a first embodiment.

A log normalization apparatus 1 is implemented by a hardware configuration such as a computer illustrated in FIG. 2 as an example. The log normalization apparatus 1 includes a control unit 2, a pattern matching unit 3, a software identification unit 4, an input/output unit 5 having a GUI function, a pattern generation unit 6, pattern information 7, software information 8, and history information 9. The pattern matching unit 3 receives an unprocessed log 14 from the outside such as an APP system 11 operating at a host 10, and outputs a normalized log 15 to an external storage 12 or the like. The software identification unit 4 receives configuration information 16 input from an external user terminal 13 used by a user such as an administrator via the input/output unit 5. For exchanging data with the outside, for example, a Web API may be used, the data may be read from a recording medium such as a magnetic disk apparatus, or, when the data is a small amount of configuration information, the data may be input on a screen of a user terminal. Hereinafter, a case in which the log normalization apparatus 1 communicates with the host 10, the storage 12, and the user terminal 13 will be described as an example, but the present technique is not limited thereto and can be used in various environments in which a log is output.

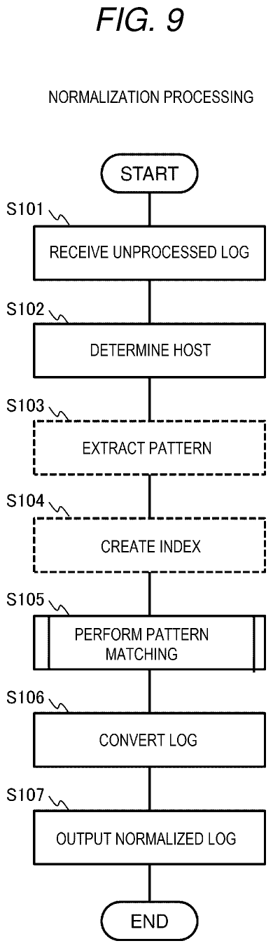

When the unprocessed log 14 is input, the pattern matching unit 3 analyzes and converts the log by using the pattern information 7 and outputs the normalized log 15 to the storage 12 such as an external storage apparatus or a cloud (described in detail in FIG. 9).

The software identification unit 4 identifies software used by a generation source of the log such as the host 10 by using the history information 9 and the configuration information 16, and registers an identification result in the software information 8 (described in detail in FIG. 8).

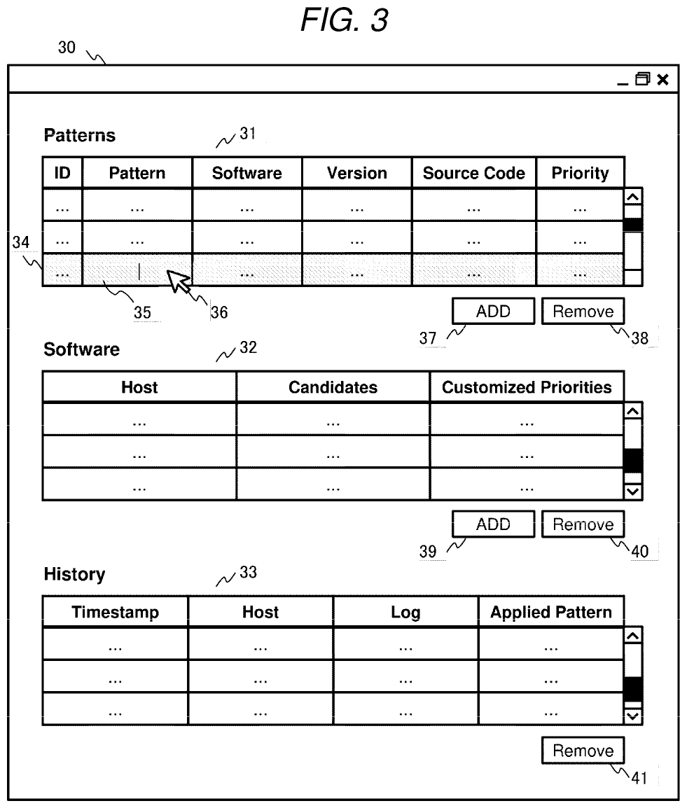

The input/output unit 5 receives confirmation, addition, removal, and update of data of the pattern information 7, the software information 8, and the history information 9 based on a user's operation from the user terminal 13 or the like, for example, by a GUI function (described in detail in FIG. 3).

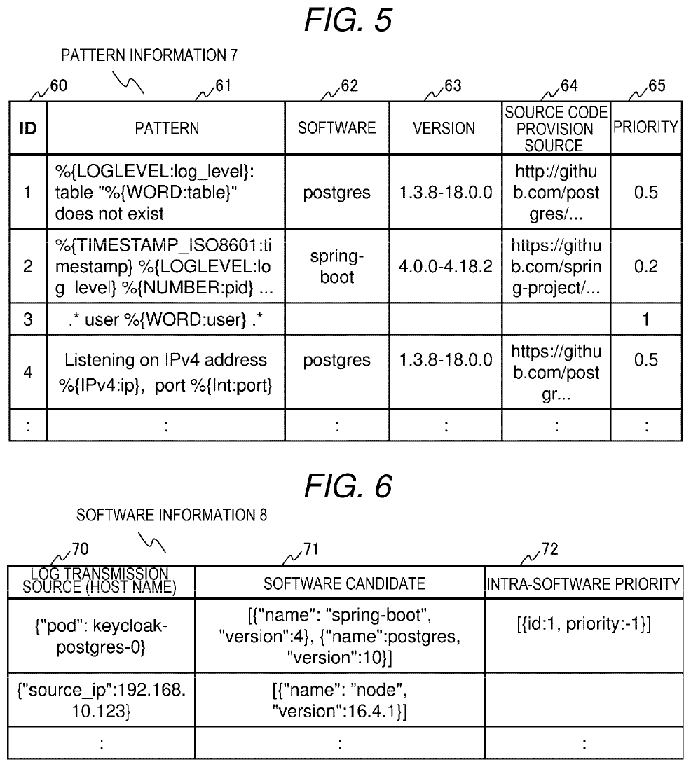

The pattern information 7 is a table that retains templates (patterns) for analyzing unprocessed logs (described in detail in FIG. 5).

The software information 8 is a table that retains candidates for software supposed to be operating on a host to be processed (described in detail in FIG. 6). The software information 8 is used in the pattern matching unit 3 so as to reduce a search range of matching.

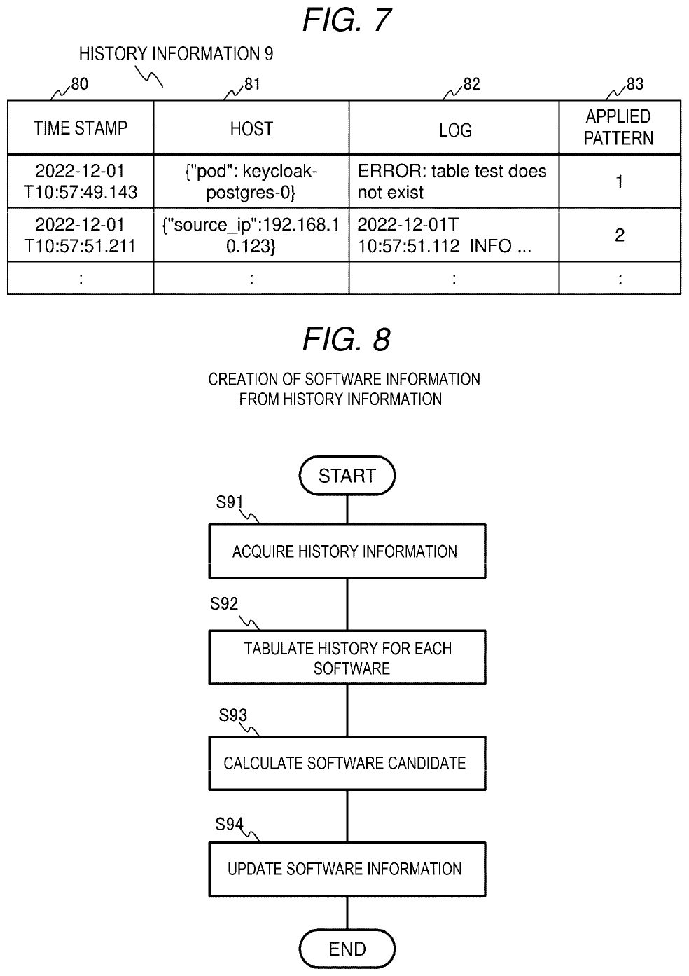

The history information 9 is a table that retains data of the unprocessed log 14 received by the pattern matching unit 3 and a pattern applied for normalization (described in detail in FIG. 7). The history information 9 is used in the software identification unit 4 so as to identify software.

The unprocessed log 14 is data including a character string of an unstructured log and host information. The host information is information for determining a transmission source of a log, and is, for example, an IP address of a transmission source, a host name, a container name, a Pod name of Kubernetes (registered trademark), or a combination thereof, and is expressed in a data format such as JSON, for example.

The normalized log 15 is normalized data obtained by normalizing the unprocessed log 14 into a structured log by the log normalization apparatus 1, and includes a character string of the structured log. In addition, the normalized log 15 may also include, as metadata, information of software (a software name, a version, a source code URL, a line number, and the like) which is a generation source of a log. The metadata can be used as reference information for debugging, for example.

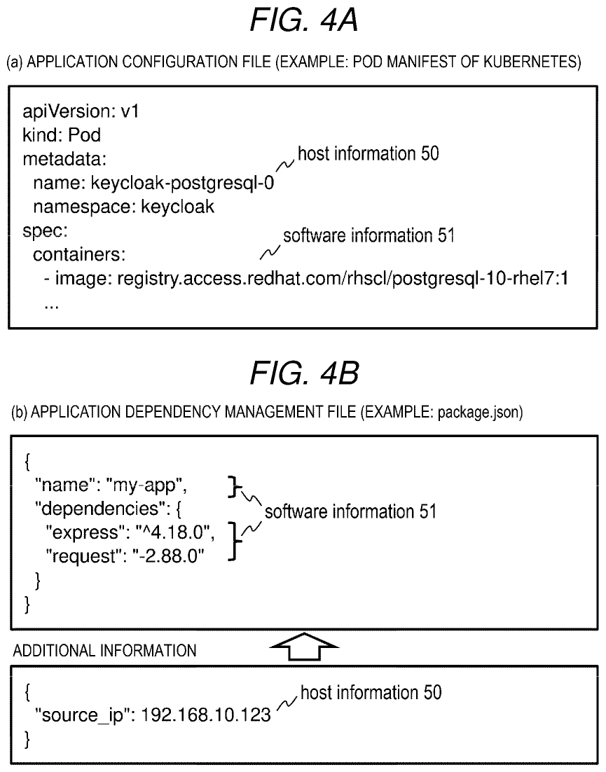

The configuration information 16 is data used for identifying software in the software identification unit 4, and includes, for example, a dependency management file and a configuration file of software that generates a log (described in detail in FIGS. 4A and 4B).

The unprocessed log 14, the normalized log 15, and the configuration information 16 include data in the form of character string, a file, encoded binary data, and data stream.

In order to improve the efficiency of pattern searching, the pattern information 7 may include data of an index in addition to the table. In the present embodiment, this index is referred to as an overall index. The configuration of the index varies depending on a pattern searching method, and may be in the form of, for example, a table to which a TF-IDF value of each pattern is added, an ordered tree based on the structures of patterns, or a table in which patterns are simply arranged in ascending order of a priority 65 of the pattern information 7. The ordered tree based on the structures of patterns is a tree structure adjusted such that a more inclusive pattern becomes a parent, and has a structure in which, for example, when there are a pattern A “·*% {WORD:user}·*”, a pattern B “·*% {WORD:user} log in·*”, a pattern C “·*% {WORD:user} log out·*”, and a pattern D “·*admin % {WORD:user} log in·*”, the pattern A is a parent, the patterns B and C are children of the pattern A, and the pattern D is a child of the pattern B. In addition, sibling nodes are arranged such that a pattern whose priority 65 shown in FIG. 5 is smaller (which has a higher priority) is searched earlier.

FIG. 2 is a block diagram illustrating an example of a hardware configuration of the log normalization apparatus 1. This hardware configuration may be a physical computer, or may operate in a unit of a computer which is obtained by logically dividing a physical computer and is called a virtual server. Alternatively, this configuration may be a task (also referred to as a process or a container) that is executed on a single computer or a cluster of a plurality of computers.

An electronic computer 20 includes a processor 21 such as a Central Processing Uint (CPU), a communication control unit 22, a communication interface 23, a main storage unit 24, and an auxiliary storage unit 25. The processor 21, the communication control unit 22, the communication interface 23, the main storage unit 24, and the auxiliary storage unit 25 are connected to each other by an internal bus 26.

The processor 21 is hardware that controls operations. The main storage unit 24 is a storage unit that retains various programs and data, and a semiconductor memory is used, for example.

The auxiliary storage unit 25 is a storage unit having a large storage capacity and is, for example, a hard disk unit or a Solid State Drive (SSD). The auxiliary storage unit 25 retains execution files of various programs. The auxiliary storage unit 25 is accessible from the processor 21.

The communication control unit 22 is hardware having a function of controlling communication and is used to exchange data between with the outside and the log normalization apparatus 1 in FIG. 1. The communication control unit 22 is connected to a network 27 via the communication interface 23.

FIG. 3 illustrates an example of an input screen 30 which is a GUI screen provided by the GUI function of the input/output unit 5 of the log normalization apparatus 1. By using this screen, a user can confirm, add, remove, and update the data of the pattern information 7, the software information 8, and the history information 9.

The input screen 30 includes ADD buttons (37, 39) for adding new data to and Remove buttons (38, 40, 41) for removing existing data from tables in which the pattern information 7, the software information 8, the history information 9, and various other information (not illustrated) are stored.

The input/output unit 5 displays the data of the pattern information 7 at a pattern information input portion 31. The input/output unit 5 receives an operation from an operator using an input device such as a mouse or a keyboard, and makes any cell 35 or any row 34 of the pattern information input portion 31 selectable 36. Upon receiving an input of letters or figures via a keyboard or the like, the input/output unit 5 can update the value of the selected cell 35.

Upon receiving pressing of the Remove button 38 in a state in which the row 34 is selected, the input/output unit 5 can remove the selected row 34. Upon receiving pressing of the ADD button 37 by an operator, the input/output unit 5 creates a new row at the pattern information input portion 31. Upon receiving an input of data to the newly added row by an operator, the input/output unit 5 can add a new record to the pattern information 7. However, when the ID of the added row is not a unique value, the input/output unit 5 displays an error and skips registration processing. The data added, removed, or updated at the pattern information input portion 31 is reflected on the pattern information 7.

The input/output unit 5 displays the data of the software information 8 at a software information input portion 32. As with the pattern information input portion 31, upon receiving an operation of the ADD button 39 or the Remove button 40 or edition of a cell of the software information input portion 32, the input/output unit 5 can add, remove, or update the data of the software information 8. Similarly, the input/output unit 5 can display the data of the history information 9 at a history information input portion 33 and, upon receiving an operation of the Remove button 41 or edition of a cell, remove or update the data of the history information 9.

FIGS. 4A and 4B are examples of the configuration information 16. A format of the configuration information 16 and a method of generating the software information 8 using the configuration information 16 in the software identification unit 4 will be described using FIGS. 4A and 4B.

The configuration information 16 is data used for identifying software in the software identification unit 4, and includes, for example, a dependency management file and a configuration file of software that generates a log. FIG. 4A illustrates, as an example of a configuration file, an example of (a) a manifest used in Kubernetes (registered trademark) which is a container orchestrator. FIG. 4B illustrates, as an example of a dependency management file, an example of (b) package.json used in Node.js. The configuration information 16 also includes docker-compose.yml, Dockerfile, go.mod, pom.xml, requirement.txt, build.gradle, and the like in addition to the manifest and package.json.

The configuration information 16 includes host information 50 and software information 51. The host information 50 includes information (an IP address, a host name, a container name, a Pod name, and the like) for identifying a computer or a process that is a generation source of a log. The software information 51 includes information on software and library used by a subject indicated by the host information 50.

In (a) Kubernetes manifest in FIG. 4A, metadata.name can be used as the host information 50 and spec. containers [*].image can be used as the software information 51. In (b) package.json in FIG. 4B, name or dependencies can be used as the software information 51. However, since package.json does not include the host information 50, when package.json is used as the configuration information 16, the host information 50 is added as additional information in a format such as JSON.

The software identification 4 receives the unit configuration information 16 via the input/output unit 5, and when the configuration information 16 is input, determines a file type indicating the format of the configuration information 16 from the file name and the data configuration, and then performs extraction and processing of the host information 50 and the software information 51 by a treatment predetermined for each file type, and registers them in the software information 8. For example, in the case of the Kubernetes manifest, the processing includes a process of changing the key name of host information 401A from metadata.name to pod so as to match the host information 401A with the host information of an unprocessed log 120 in terms of data format. The processing also includes a process of extracting a container image name (postgresql-10-rhel7) from spec. container [*]·image (registry.access.redhat.com/rhscl/postgr esql-10-rhel7:1) and normalizing the software name and the version information ({“name”: “postgres”, “version”: 10}) using a dictionary provided in advance in the software identification unit 4.

At the time of initial registration in the software information 8, the value of an intra-software priority 72 to be described below with reference to FIG. 6 is set to be null. This is because the value of the intra-software priority 72 is a value added by an operator's operation on the input screen 30.

FIG. 5 is an example of the data structure of the pattern information 7. The pattern information 7 is a table that retains templates (patterns) for analyzing the unprocessed log 14 and is used in the pattern matching unit 3.

The pattern information 7 includes respective values of an ID 60, a pattern 61, software 62, a version 63, a source code provision source 64, and the priority 65.

The ID 60 is an identifier of each record and has a unique value in the log normalization apparatus 1.

The pattern 61 is a character string serving as a template for analyzing a log, and is used to extract a parameter from an unstructured log. As the pattern 61, for example, a regular expression or Grok (registered trademark) pattern may be used.

The software 62 represents the name of software that generates a log of the pattern 61, and the version 63 represents the version of the software that generates the log of the pattern 61. As the version 63, a plurality of values (e.g., 1.0.0, 1.0.2) may be listed or a range (e.g., 1.0.0-2.3.5) may be designated.

The source code provision source 64 is the information of a source code in which output processing of the log is implemented in the software 62. The source code provision source 64 is indicated by a file name or a URL when a source code is disclosed in a repository on the Internet, and may include information of a line number.

The priority 65 represents a degree to which the pattern 61 is given priority over other patterns. The priority 65 indicates that priority is given to a smaller value, and, for example, the reciprocal of the number of stars acquired by the repository of the software in GitHub (registered trademark) can be used. The priority affects the search order in the pattern matching unit 3.

When there is a plurality of log patterns for one software, a priority can be set for each log pattern. In this example, it is designated that the software postgres has patterns of ID 1 and ID 4 that have the same priority.

FIG. 6 is an example of the data structure of the software information 8. The software information 8 retains candidates for software operating at each host and is used in the pattern matching unit 3 so as to reduce a range of pattern searching.

The software information 8 includes respective values of a log transmission source 70, a software candidate 71, and the intra-software priority 72. The log transmission source 70 is information indicating a computer or a process that is a transmission source of a log, and is configured by an IP address of a transmission source, a host name, a container name, a Pod name of Kubernetes, or a combination thereof. The data format of the log transmission source 70 is represented, for example, in JSON format.

The software candidate 71 represents information of the software or library operating at the log transmission source 70, and includes information of a list of the names of the software. In addition, information of the name as well as the corresponding version of each software may be included.

The intra-software priority 72 is a value for individually customizing the priority 65 of the pattern information 7 for each log transmission source 70, and is configured by a set of zero or more IDs and priorities. The ID represents the ID 60 of the pattern information 7, and the priority represents a priority newly set to the ID. The intra-software priority 72 can be set when the input/output unit 5 receives edition in the software information input portion 32 by an operator on the input screen 30. In addition, when the input/output unit 5 receives an operation in the history information input portion 33 by an operator on the input screen 30 and corrects an error of the history information 9, a priority having a value smaller than the priority 65 of a pattern registered before this change may be set to a pattern after the change. This makes it possible to prevent reproduction of an error in pattern searching.

In this example, it is specified that the priority order of the pattern registered in ID 1 of the pattern information is set to “−1” by designating [{id: 1, priority: −1}] in the intra-software priority. Thus, the pattern of the software postgres of ID 4 is given priority over the pattern of the software postgres of ID 1.

FIG. 7 is an example of the data structure of the history information 9. The history information 9 retains information of a log normalized by the log normalization apparatus 1, and is used for software identification in the software identification unit 4 as well as content confirmation on the input screen 30.

The history information 9 includes respective values of a time stamp 80, a host 81, a log 82, and an applied pattern 83. The time stamp 80 is information of the time of normalization of a target log by the log normalization apparatus 1, and is represented in a character string in the ISO8601 format or a Unix Epoch value.

The host 81 is information representing a computer or a process which is a log transmission source expressed in the same specification as the log transmission source 70 of the software information 8. The log 82 is a character string of the unprocessed log 14 input in the log normalization apparatus 1. The applied pattern 83 is the ID 60 of the pattern information 7 used to normalize the log 82.

A process of the identification processing performed using the history information 9 by the software identification unit 4 will be described in detail with reference to FIG. 8.

FIG. 8 is an example of software identification processing using the history information 9 in the software identification unit 4. In this processing, the software operating at a target host is identified from the tendency of a pattern applied in log analysis, and the software information 8 is updated. It should be noted that one or more steps of the processing illustrated in FIG. 8 may be omitted, or the order of the steps may be changed. The same applies to the subsequent processing steps in FIGS. 9, 10, and 11.

The software identification unit 4 performs the processing of steps S91 to S94 for each host at predetermined fixed timing. Thus, although S91 to S94 are described as processing for one specific host, the same is applied to other hosts.

The software identification processing is performed at a timing based on a value received by the input/output unit 5 from the user terminal 13, and the control unit 2 controls when an identification processing result is reflected in matching processing, thereby flexibly responding to the addition of a host or an application system. Of course, another unit may perform the same control in place of the control unit 2.

First, the software identification unit 4 acquires records having a specific host 81 from the history information 9 (S91). A limitation may be set on records to be acquired. As the limitation, for example, the number of records (e.g., the latest 1000 records) or time (e.g., the past 12 hours), or a combination thereof can be used. This makes it possible to prevent old records from reducing the accuracy of software identification.

Next, the software identification unit 4 tabulates the acquired records for each set of software and version, and counts the number of records for each set of software and version (S92). Specifically, the software identification unit 4 acquires, from the pattern information 7, records that have the pattern 61 corresponding to the ID 60 having the same value as the applied pattern 83 of the acquired records. For the values of the software and the version corresponding to the pattern 61 included in the acquired pattern information 7 in the tabulation of the acquired records, when there are record groups in which the software is the same and the versions have an inclusion relationship, the software identification unit 4 consolidates these record groups. For example, a record group in which the software is postgres and the version is 17.0.0 may be added to a record group in which the software is postgres and the versions are in the range of 1.3.8-18.0.0. With this processing, the number of the sets of software and version that correspond to the applied pattern 83 can be tabulated for each host 81.

Next, the software identification unit 4 calculates a software candidate for the host from the tabulation result (S93). The software identification unit 4 selects, as a software candidate, a set of software and version that have a predetermined number or more (e.g., 30 or more) records in the tabulation result of S92, or that is in a predetermined order or higher (e.g., 3 or higher) when the tabulated number of records is sorted in descending order. There may be a plurality of software candidates. When there is no applicable candidate, the software identification unit 4 determines that there is no software candidate. With this processing, a software candidate corresponding to a pattern applied at the time of normalization of an unprocessed log can be obtained for each host based on the past results.

Finally, the software identification unit 4 registers the calculated software candidate to the software information 8 (S94). Specifically, when there is a record in which the log transmission source 70 has the same value as the host in the software information 8, the software identification unit 4 updates (adds or overwrites) the calculated software candidate to the software candidate 71 of the record. On the other hand, when there is no applicable record, the software identification unit 4 registers a host and a software candidate as a new record. At this time, the software identification unit 4 expresses the software candidate in a data format such as JSON format.

By the above-described processing, the software identification unit 4 calculates a software candidate for a host and updates the software information 8 based on the history information 9.

FIG. 9 is an example of pattern matching processing in the pattern matching unit 3. In this processing, the input unprocessed log 14 is converted into the normalized log 15 by using pattern matching.

The pattern matching unit 3 receives the unprocessed log 14 from the outside and starts a series of processing (S101). The pattern matching unit 3 receives the unprocessed log 14, for example, via a Web API or a file. When a plurality of unprocessed logs 14 are sequentially input as a file, a datastream, or the like, the pattern matching unit 3 separates the unprocessed logs 14 into individual units based on the number of characters or specific separators (e.g., line feed marks), and performs the subsequent processing on each unprocessed log 14.

Next, the pattern matching unit 3 extracts host information from the received unprocessed log 14 (S102).

Next, the pattern matching unit 3 extracts a pattern to be searched based on the information of software operating at the host which is the generation source of the unprocessed log 14 (S103). However, this processing (S103) and the subsequent index creation (S104) may be performed when the software identification unit 4 registers the software information 8 in S94 (e.g., after S94), other than during pattern matching. Although it is more efficient to perform these processing steps by the software identification unit 4, these processing steps are described as the processing steps performed by the pattern matching unit 3 in the first embodiment in order to explain the features of the invention in an easy-to-understand manner.

Specifically, the pattern matching unit 3 acquires a record in which the log transmission source 70 matches the host information extracted in S102 from the software information 8 and obtains the software candidate 71 thereof. Then, the pattern matching unit 3 extracts, from the pattern information 7, a record in which the software 62 and the version 63 match the value of the software candidate 71. As explained in FIG. 8, the software information 8 is updated based on the history information 9. Therefore, by performing this processing, it is possible to obtain the software 62 and the version 63 corresponding to the software candidate 71 obtained from the latest software information 8 based on past results. In S103, one or more patterns 61 that match in terms of the software 62 and the version 63 are extracted, and, from among them, a pattern corresponding to the unprocessed log 14 is searched in the processing in S105 described below.

However, matching in terms of the version 63 includes the case where the value of the version of the software candidate 71 is included in the range or the list of the version 63. When there is no completely-matching software 62, the pattern matching unit 3 may, for example, determine the similarity between the software name in the software candidate and the character string in the software 62 using Levenshtein distance or the like, and determine the software 62 for which the distance is equal to or less than a predetermined value as a matching software.

Next, the pattern matching unit 3 creates an index for efficiently searching extracted patterns (S104). The index created in this processing is referred to as an individual index. The structure and the creation method of the individual index are the same as those of the overall index illustrated in FIG. 1.

Next, the pattern matching unit 3 searches for a pattern corresponding to the unprocessed log 14 using the index (S105). In pattern searching, the pattern matching unit 3 searches the individual index first, and when there is no applicable pattern, searches the overall index. The search method depends on the format of the index. When the index is configured by TF-IDF, the pattern matching unit 3 extracts patterns in which a difference from the TF-IDF value of the unprocessed log 14 is equal to or less than a predetermined value, and evaluates the patterns that can express the unprocessed log 14 in ascending order of the priority 65. When the index is an ordered tree, the pattern matching unit 3 evaluates whether patterns can express the unprocessed log 14 by searching with a priority given to the depth from the root, and searches for a node having no child or sibling node or a node which cannot express the unprocessed log 14. In the case of a table sorted in ascending order of the priority, the pattern matching unit 3 evaluates whether the unprocessed log 14 can be expressed from the top. When no applicable pattern is found, the pattern matching unit 3 returns an error and the subsequent processing is skipped.

Next, the pattern matching unit 3 extracts a parameter from the unprocessed log 14 based on the regular expression or the Grok pattern of the pattern found in S105 and converts the parameter into a data structure such as JSON (S106). At this time, the pattern matching unit 3 may add metadata to JSON as an additional parameter. The metadata includes, for example, an original text of the unprocessed log 14, host information, a processing time, a name of software determined as a log generation source, a version of the software, a source code of the log generation source, and the like.

Next, the pattern matching unit 3 outputs the log converted in S106 as the normalized log 15 and registers the result in the history information 9. The pattern matching unit 3 registers the processing time as the time stamp 80, the host information included in the unprocessed log 14 as the host 81, and the original text of the log as the log 82, and the ID of the pattern whose log is processed as the applied pattern 83 in the history information 9 (S107).

By the above-described processing, the pattern matching unit 3 can convert the unprocessed log 14 into the normalized log 15.

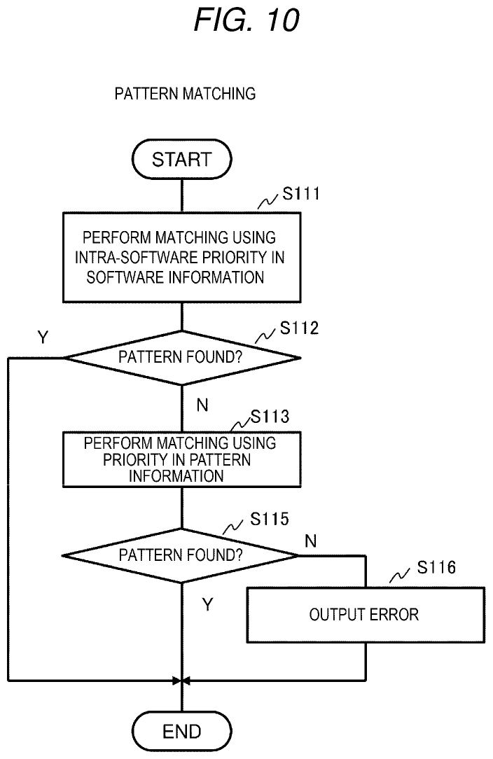

Next, the pattern matching processing in S105 will be described with reference to FIG. 10. FIG. 10 is an example of a flowchart explaining pattern matching processing according to the present embodiment.

In the following, the pattern matching unit 3 performs matching of an unprocessed log subjected to pattern matching by using software information that is information of a program operating at a log transmission source. The intra-software priority 72 is stored in the software information 8, and which pattern stored in the pattern information 7 is a pattern associated with the program operating at the log transmission source is designated by a link provided in the ID 60 of the pattern information 7. In addition, the priority in the linked pattern is designated as the intra-software priority 72.

The pattern matching unit 3 performs pattern matching of linked patterns among the patterns 61 of the pattern information 7 extracted in S103 in the order designated by the intra-software priority 72 of the software information 8 (S111). This makes it possible to find a pattern to be applied to the unprocessed log quickly and properly.

The pattern matching unit 3 determines whether a pattern has been found by the matching using the software information 8 and the pattern information 7 (S112) and, when it is determined that a pattern has been found (S112; Yes), terminates the processing. On the other hand, when it is determined that no pattern has been found (S112; No), the pattern matching unit 3 performs pattern matching in the order of the priority 65 of the pattern information 7 (S113). Subsequently, the pattern matching unit 3 determines whether a pattern has been found by the pattern matching using the pattern information 7 (S115), and when it is determined that a pattern has been found (S115; Yes), terminates the processing. On the other hand, when it is determined that no pattern has been found (S115; No), the pattern matching unit 3 outputs an error (S116).

In the present embodiment, an example in which the order of performing pattern matching is controlled at the time of creating an index has been described, but the control unit 2 may change the order of use of files in which priorities used for pattern matching are stored.

### Second Embodiment

In the second embodiment, the pattern information 7 is generated from source code information 17. Accordingly, a user can generate a pattern of a log from a source code of software without creating the pattern information 7 for each log. The second embodiment will be described with reference to the system configuration diagram illustrated in FIG. 1. Although the pattern generation unit 6 and the source code information 17 are required in addition to the components of the first embodiment, the other components are the same as those illustrated in FIG. 1, and thus the descriptions thereof will be omitted.

The pattern generation unit 6 performs processing of generating the pattern information 7 based on the source code information 17.

The source code information 17 is data in which source codes of software and libraries and metadata are combined. A source code is a character string that represents a program of software, and may be information of all files included in a repository of Git (registered trademark) of the software or the like or a part thereof. Metadata is information that indicates the name and the priority of software and includes information of a software name, a version, a source code provision source, a priority, and the like. Metadata may be generated from a source code in the pattern generation unit 6.

The source code information includes data in the form of a character string, a file, encoded binary data, and data stream, and is input from the outside as a Web API or a file.

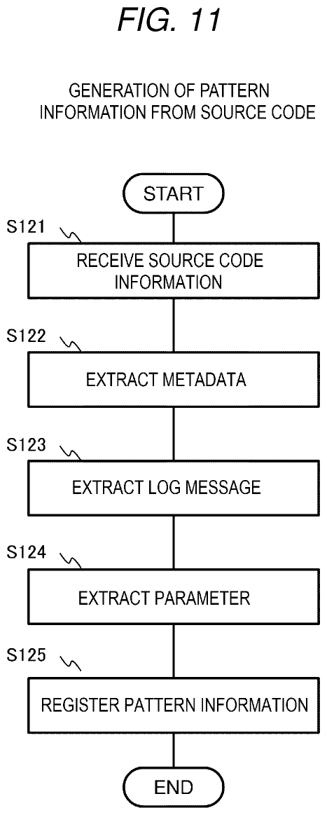

FIG. 11 is an example of pattern generation processing in the pattern generation unit 6. The pattern generation unit 6 generates the pattern information 7 from the source code information 17.

The pattern generation unit 6 receives the source code information 17 from the outside via the input/output unit 5 and starts a series of processing (S121).

Upon receiving the source code information 17, the pattern generation unit 6 confirms whether a software name, a version, a source code provision source, and a priority are included in the metadata of the source code information 17. When there is data that does not include these information, the pattern generation unit 6 attempts to generate metadata from the source code.

The pattern generation unit 6 acquires a software name from a repository name of the source code, a configuration file (package.json, go.mod, setup.py, or the like) in the source code, or a title (e.g., an H1 tag of HTML) in a README file. In the case of acquiring a software name from a configuration file, the pattern generation unit 6 identifies the software name by processing predetermined for each configuration file. For example, when the configuration file is package.json, the pattern generation unit 6 sets a name parameter as the software name. At time, the pattern generation unit 6 may performs this preprocessing on the software name such as lowercasing alphabetic characters or replacing spaces with underscores.

As in the case of acquiring the software name, the pattern generation unit 6 also acquires a version and a source code provision source from a configuration file in the source code by processing predetermined for each configuration file. For example, when the configuration file is package.json, the pattern generation unit 6 sets a version parameter and a homepage parameter as the version and the source code provision source, respectively.

When the source code provision source is a repository having an evaluation function (the number of stars, weekly downloads, or the like) such as GitHub or GitLab (registered trademark), or NPM (registered trademark), the pattern generation unit 6 can access the URL of the source code provision source, acquire the evaluation value of the source code by a method predetermined for each source code provision source, and set the evaluation value as a priority. For example, when the source code provision source is GitHub, the pattern generation unit 6 may set the reciprocal of the number of stars as the priority. The range of the priority value may be normalized for each type of repository.

When no software name is included in the metadata and cannot be generated from the software, the pattern generation unit 6 returns an error and skips the subsequent processing. When the version 63 and the source code provision source 64 cannot be acquired, the pattern generation unit 6 sets the version 63 and the source code provision source 64 to be blank. When the priority 65 cannot be acquired, the pattern generation unit 6 sets the priority 65 to be 1 as a default value.

Next, the pattern generation unit 6 extracts a log message from the source code (S123). A log message is data that represents a document to be output as a log and is configured by a character string, a variable, a function, a class, or an attribute, or a combination thereof. The pattern generation unit 6 identifies the log message by processing such as syntax analysis and semantic analysis predetermined for each programming language, and acquires the date and the line number of the log message. For example, in the case of JavaScript, the pattern generation unit 6 can acquire an argument of a function (debug function, etc.) of a logging library such as console.log function and Log 4js as the log message.

In addition, when the log message is implemented by a variable, a function, a class, an attribute, or the like, the pattern generation unit 6 may identify a variable, a function, a class, or an attribute associated with a function that outputs a log using, for example, an abstract syntax tree of the source code, and may acquire a value or an argument thereof as the log message. Further, when a fixed-form character string of the log message to be output at a time is divided into a plurality of character strings, the pattern generation unit 6 may combine the character strings into one fixed-form character string and then acquire the fixed-form character string as the log message. The above-described fixed-form character string is, for example, a character string that can be statically determined only from the source code, and does not include data to be dynamically determined such as a variable. When a plurality of log messages are acquired from the source code, the pattern generation unit 6 performs the subsequent processing for each log message.

Next, the pattern generation unit 6 extracts a parameter from the log message and assigns a parameter name and a data type (S124). A parameter is a value extracted from a log message in a structured log such as user or source_ip. The pattern generation unit 6 extracts a dynamically-determined variable or a function embedded in the log message as a parameter. At this time, the pattern generation unit 6 identifies data of each extracted parameter by using a syntax extraction tree, and when the parameter has a plurality of pieces of data (e.g., a transmission source IP address and a transmission source port number), the pattern generation unit 6 may divide the parameter into a plurality of parameters for each data by tracing the syntax extraction tree.

The pattern generation unit 6 acquires a parameter name from the name of the variable or the function. At this time, in order to normalize the parameter name, the pattern generation unit 6 may select an appropriate parameter name from among predetermined parameter name candidates in accordance with the name of the variable or the function or the meaning of the log message. The pattern generation unit 6 can use, for example, a process of comparing each parameter candidate with the variable, the function, or the meaning of the log message using character vectors or distances in a concept dictionary by using Word2Vec, BERT, or the like, and selecting a parameter having the closest meaning among the parameter candidates.

The pattern generation unit 6 determines the data type of the parameter from the variable type of the variable or the data type of the return value of the function. As a data type, for example, a data type defined as a Grok pattern can be used in addition to a primitive value such as a character, a numerical value, a truth value, or a binary. In the case of a programming language having no variable type or in the case of a data type in which a variable is uniquely defined, the pattern generation unit 6 can determine an associated data type using a syntax extraction tree and identify the data type as the data type of the parameter.

Finally, the pattern generation unit 6 generates a pattern from the extracted log message and the parameter, and registers the pattern in the pattern information 7 together with the metadata (S125). The pattern generation unit 6 can generate the above-described pattern by replacing the parameter in the log message with a regular expression, Grok pattern, or the like. At this time, the pattern generation unit 6 may perform post-processing on the generated pattern so as to improve a matching accuracy. In the post-processing, for example, by adding a regular expression “·*” to the head of the pattern, even when a prefix is added to the log message outside the software, the log message can be handled as a log message for which matching can be performed.

In registration to the pattern information 7, the pattern generation unit 6 registers the pattern as the pattern 61, and registers the software name, the version, the source code, and the priority of the metadata as a software 502, a version 503, a source code 504, and a priority 505, respectively. Then, the log normalization apparatus 1 assigns a unique ID 60 to generate a record of the pattern information 7.

By using the processing and the information described above, the log normalization apparatus 1 can generate the pattern information 7 from the source code information 17. Accordingly, an effect of eliminating the need for a user to create the pattern information 7 for each log can be achieved.

As described above, according to the present embodiment, the log normalization apparatus 1 for normalizing a log output from an information processing system into a structured log includes: a log input unit (the pattern matching unit 3) configured to receive a log output from the information processing system; a storage unit (the auxiliary storage unit 25) configured to store the pattern information 7, which is patterns of a plurality of logs, and a first priority information (the intra-software priority 72 of the software information 8) indicating a first priority for pattern matching corresponding to a log transmission source; the pattern matching unit 3 configured to, when the log received is the log transmission source corresponding to the first priority information, perform pattern matching between the log and the patterns in the pattern information 7 using a pattern corresponding to the first priority and convert the log into a normalized log using the pattern matched; and a log output unit (the pattern matching unit 3) configured to output the normalized log converted by the pattern matching unit 3. Accordingly, it is possible to improve an accuracy and a processing speed for searching in searching for a pattern that matches a log.

In addition, the patterns in the pattern information each include a second priority (the priority 65 of the pattern information 7) indicating the priority for pattern matching, and the pattern matching unit performs pattern matching using the second priority when the pattern matching based on the first priority finds no matched pattern. This makes it possible to perform the pattern matching using the second priority even when the pattern matching based on the first priority finds no matched pattern.

In addition, the first priority may be a priority order defined based on the software operating at a log transmission source. With such a specification, the priority order of patterns to be applied can be determined in accordance with the type of software that outputs a log, or in accordance with the type of version of the same software.

In addition, the first priority may include an instruction to change the second priority associated with the pattern information included in the pattern information. With such a specification, the priority 65 of the pattern information 7 can be individually customized.

In addition, the first priority may be a priority order defined based on the evaluation of the software operating at a source code provision source. With such a specification, the priority that reflects the evaluation of the source code can be defined by a method defined for each source code provision source.

The input/output unit 5 is further included, the input/output unit 5 being configured to receive update information for the second priority and change the second priority included in the pattern information by using the received update information. Thus, the priority can be changed to a value intended by a user.

In addition, a source code of the software operating at the log transmission source is received, a pattern is created based on a parameter included in the source code, and the created pattern is registered in the pattern information. This makes it possible to eliminate the need for a user to create the pattern information 7 for each log.

In addition, semantic analysis of the received source code is performed, a log message is output from the positions and names of a variable and a function included in the source code, a parameter is extracted from the output log message, and a pattern of the pattern information 7 is generated based on the output log message and the extracted parameter. This makes it possible to estimate the position and the role of the parameter included in the log message to be output using the information obtained by the semantic analysis to create a pattern and obtain a parameter included in the pattern.

The invention has been described in detail with reference to the drawings, but is not limited to the above-described various examples, and various modifications can be made without departing from the scope of the present invention.

What is claimed is:

1. A log normalization apparatus for normalizing a log output from an information processing system into a structured log, the log normalization apparatus comprising:
a log input unit configured to receive a log output from an information processing system;
a storage unit configured to store pattern information and first priority information, the pattern information being patterns of a plurality of logs, the first priority information indicating a first priority for pattern matching corresponding to a log transmission source;
a pattern matching unit configured to, when the log received is a log transmission source corresponding to the first priority information, perform pattern matching between the log and the patterns in the pattern information using a pattern corresponding to the first priority and convert the log into a normalized log using the pattern matched; and
a log output unit configured to output the normalized log converted by the pattern matching unit.

2. The log normalization apparatus according to claim 1, wherein
the patterns in the pattern information each include a second priority indicating a priority for pattern matching, and
the pattern matching unit performs pattern matching using the second priority when pattern matching based on the first priority finds no matched pattern.

3. The log normalization apparatus according to claim 2, wherein the first priority is a priority order defined based on software operating at a log transmission source.

4. The log normalization apparatus according to claim 2, wherein the first priority includes an instruction to change the second priority associated with the pattern information included in the pattern information.

5. The log normalization apparatus according to claim 3, wherein the first priority is a priority order defined based on evaluation of software operating at a source code provision source.

6. The log normalization apparatus according to claim 2, further comprising an input/output unit configured to receive update information for the second priority and change the second priority included in the pattern information by using the update information received.

7. The log normalization apparatus according to claim 2, wherein a source code of software operating at a log transmission source is received, a pattern is created based on a parameter included in the source code, and the pattern created is registered in the pattern information.

8. The log normalization apparatus according to claim 7, wherein semantic analysis of the source code received is performed, a log message is output from positions and names of a variable and a function included in the source code, a parameter is extracted from the log message output, and a pattern of the pattern information is generated based on the log message output and the parameter extracted.

9. A log normalization method for normalizing a log output from an information processing system into a structured log, the log normalization method comprising:
receiving, by a log input unit, a log output from an information processing system;
storing, by a storage unit, pattern information and first priority information, the pattern information being patterns of a plurality of logs, the first priority information indicating a first priority for pattern matching corresponding to a log transmission source;
when the log received by the log input unit is a log transmission source corresponding to the first priority information, performing, by a pattern matching unit, pattern matching between the log and the patterns in the pattern information using a pattern corresponding to the first priority and converting, by the pattern matching unit, the log into a normalized log using the pattern matched; and
outputting, by a log output unit, the normalized log converted by the pattern matching unit.

10. The log normalization method according to claim 9, wherein
the patterns in the pattern information each include a second priority indicating a priority for pattern matching, and
the pattern matching unit performs pattern matching using the second priority when pattern matching based on the first priority finds no matched pattern.
